(19) United States
(12) Patent Application Publication
(10) Pub. No.: US 2009/0028617 A1
(43) Pub. Date: Jan. 29, 2009

(54) FIXING APPARATUS, HEATING ROLLER, AND IMAGE FORMING DEVICE

(75) Inventors: Noboru Katakabe, Kyoto (JP); Naoto Matsuo, Fukuoka (JP); Satoru Miyanishi, Fukuoka (JP); Yasuyuki Hanada, Fukuoka (JP); Masaru Imai, Osaka (JP); Hideki Tatematsu, Hyogo (JP); Shigemitsu Tani, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/908,535

(22) PCT Filed: Mar. 13, 2006
(86) PCT No.: PCT/JP2006/304905

§ 371 Date: Sep. 13, 2007

(30) Foreign Application Priority Data
Mar. 15, 2005 (JP) 2005-072554
Oct. 13, 2005 (JP) 2005-298653

(51) Int. Cl. G03G 15/20; G03G 15/14

(52) U.S. Cl. 399/333; 399/328

(57) ABSTRACT

There is provided a fixing apparatus capable of reducing the warm-up time, improving the heating efficiency, and suppressing the temperature increase out of the sheet width by using a magnetic adjuster. In this apparatus, the Currie temperature Tc of the magnetic adjuster material heated by electromagnetic induction is set to 220 degrees C. or below and the fixation setting temperature of a heating member corresponding to the portion where a recording material passes during continuous sheet feed is set lower than a value than the temperature at which the relative magnetic permeability of the magnetic adjuster material begins to decrease. Thus, it is possible to obtain a large difference between the heating portion and the non-heating portion, to surely prevent excessive temperature increase of the portion out of the recording material width, to reduce the warm-up time, and improve the heating efficiency.

### TECHNICAL FIELD

The present invention relates to a fixing apparatus used in an image forming apparatus such as an electrophotographic or electrostatographic copier, facsimile machine, or printer, and more particularly to a fixing apparatus that heat-fixes an unfixed image onto a recording material by induction heating and a heating roller used therein, and an image forming apparatus that uses this fixing apparatus.

### BACKGROUND ART

In recent years, the application of induction heating to a fixing apparatus used in a copier, facsimile machine, printer, or the like, has been much investigated. In an induction heating type of fixing apparatus, an alternating current is applied to an exciting coil, and alternating magnetic flux (magnetic flux whose generation repeatedly ceases) is generated around this exciting coil. An eddy current is generated by permeation of an electrical conductor by the generated alternating magnetic flux, and heat generated in the electrical conductor by this eddy current is used to fix an unfixed image.

Specifically, for example, heat generated in the electrical conductor is transferred to a nip formed by two rollers, and when recording material passes through the nip, toner on the recording material is fixed by pressure and heat applied by the rollers. In order to transfer heat generated in the electrical conductor to the nip, for example, the rollers forming the nip may themselves be formed of conductive material, or a thin-film belt may be suspended over an electrical conductor and one of the rollers forming the nip. At this time, heat transferred to the nip is absorbed by the recording material passing through the nip and surrounding members, and therefore the temperature of the roller or belt transferring heat to the nip falls. However, as recording materials that pass through the nip may be of various widths, heat is not necessarily always absorbed uniformly from the entire width of the roller or belt.

That is to say, to take the example of a roller system in which a roller forming the nip is itself of conductive material, the entire width of the heat-producing roller made of a conductive material is not always in contact with recording material at the nip, and when narrow recording material passes through the nip, heat is not absorbed from a part that is not in contact with the recording material. Therefore, the temperature of both end parts of the heat-producing roller width may rise excessively, for example. Then, if wide recording material is passed through while the temperature of these parts is higher than a fixing temperature suitable for fixing toner, a phenomenon known as hot offset occurs whereby toner transferred to the recording material adheres to the heating roller again.

A possible way of dealing with this problem of an excessive rise in temperature is to perform auto-temperature-control using a temperature sensitive magnetic metal whose Curie temperature has been set as an electrical conductor. The Curie temperature is a temperature that is a threshold for the presence or absence of magnetism of a temperature sensitive magnetic metal, with magnetism being lost at a temperature exceeding the Curie temperature. Utilizing the characteristics of such a temperature sensitive magnetic metal, by using a material whose Curie temperature is equal to the fixing temperature as the material of an electrically conductive layer of a heat-producing film, eddy currents at or above the Curie temperature are reduced and heat production suppressed, as disclosed in Patent Document 1, for example.

Another specific example is a fixing unit that combines belt fixing and induction heating, and has a configuration that minimizes the thermal capacity of the fixing unit and shortens the warm-up time, as disclosed in Patent Document 2, for example. With this configuration, a heat-producing roller is induction-heated by an exciting coil, heat generated by the heat-producing roller is conveyed by a fixing belt to a fixing nip in contact with recording paper (recording material), and a toner image is fusion-fixed.

Generally, in a fixing unit, as described above, recording paper absorbs heat of a fixing belt, and therefore the temperature of a part of the fixing belt or fixing roller in contact with the recording paper falls. Therefore, when narrow recording paper is continuously fed through for fixing, the paper passage width part is temperature controlled and maintains a constant temperature, but a part outside the paper passage width, although heated, is not cooled by the recording paper, and therefore undergoes an abnormal rise in temperature, which may result in various kinds of problems such as bearing damage or damage to the pressure roller and/or fixing roller.

Therefore, in this case also, a possible way of dealing with this problem of an excessive rise in temperature is to perform auto-temperature-control using a temperature sensitive magnetic metal whose Curie temperature has been set to a predetermined temperature as an electrical conductor. For example, as disclosed in Patent Document 3, when narrow paper is fed through continuously while the temperature of a heating roller that is a heated member is controlled at a predetermined fixing temperature, although the temperature outside the paper passage width rises above the fixing temperature, when the temperature reaches the vicinity of the Curie temperature the calorific value of that part decreases, and thus an excessive rise in temperature outside the paper passage width is automatically suppressed.

Patent Document 1: Unexamined Japanese Patent Publication No. HEI 7-114276

### Patent Document 2: Unexamined Japanese Patent Publication No. 2002-82549

### Patent Document 3: Unexamined Japanese Patent Publication No. 2000-35724

### DISCLOSURE OF INVENTION

### Problems to be Solved by the Invention

However, there are the following kind of problems with an above-described conventional fixing apparatus.

Generally, a temperature sensitive magnetic metal produces heat due to an induction current generated internally by the penetration of magnetic flux, and therefore the electrical characteristics of the material have a major influence. There is consequently a problem of major restrictions on the shape of a heat-producing section due to resistance value and coupling inductance limitations.

That is to say, due to the necessity of equalizing the resistance value and inductance in a heat-producing section, it is not possible to use coupling that inhibits an induction current, or a nonuniform or discontinuous shape, and due to the necessity of using an endless shape of uniform thickness, it is necessary to use a belt shape or roller shape.

Since, at this time, a temperature sensitive magnetic metal produces heat due to an induction current generated internally by the penetration of magnetic flux, the heat production state is greatly influenced by the electrical characteristics of the material. That is to say, there is a problem in that, if variations in electrical characteristics are moderate in the vicinity of the Curie temperature, tracking of temperature changes in set temperature control is also sluggish, recovery is slow when heat flows to toner transferred to the recording material, and high-speed fixing cannot be performed.

At the same time, it is necessary to limit processing when performing fixing in order for fixing to be continued stably without causing offset or the like, making high-speed operation difficult.

If a temperature sensitive magnetic material that has a Curie temperature 5 to 30° C. higher than the control set temperature is used in order to improve temperature tracking, tracking of temperature changes during fixing processing is improved, and processing speed can be increased, but the temperature rises above an optimal level during heating other than at the time of fixing processing, resulting in problems such as a tendency for hot offset to occur, and the need for a wide usable temperature range for the toner.

Also, since set temperature control tracking of temperature changes is sluggish for a heat-producing element using a temperature sensitive magnetic metal, there is a problem of the length of the warm-up time until the temperature necessary for fixing is reached.

That is to say, with an image forming apparatus such as a copier, facsimile machine, or printer, when power is turned on or recovery is performed from sleep mode, the temperature of the fixing apparatus is raised to the level necessary for toner fixing, but since the rise in temperature of a temperature sensitive magnetic metal is gradual, a long time is required before image forming is actually possible. Also, if toner fixing is performed when the temperature of the fixing apparatus is insufficiently high, toner transferred to recording material does not melt properly and cold offset occurs.

Moreover, if the temperature sensitive magnetic metal Curie temperature is set high, the temperature outside the paper passage width becomes correspondingly high, and if the heating roller temperature reaches about 220° C. or higher, for example, this will adversely affect the durability of the pressure roller rubber and/or result in bearing damage.

On the other hand, a problem when the Curie temperature is too close to the fixing temperature is that the calorific value in the vicinity of the fixing temperature decreases during warm-up, and the warm-up time is lengthy.

Also, even if the Curie temperature is set high, if the rate of change of relative magnetic permeability of the temperature sensitive magnetic metal with respect to temperature is moderate, the calorific value in the vicinity of the fixing temperature decreases and energy efficiency during fixing falls, and the problem of a lengthy warm-up time arises as described above.

It is an object of the present invention to provide a fixing apparatus that enables the warm-up time to be shortened while preventing an excessive rise in temperature due to electromagnetic heating, and enables the occurrence of offset to be prevented and good, high-speed fixing to be realized.

It is a further object of the present invention to provide a fixing apparatus that, by a configuration using a temperature sensitive magnetic material in a heat-producing member heated by electromagnetic induction, enables the warm-up time of the fixing apparatus to be shortened to the maximum extent while maintaining energy efficiency during fixing in a good state, and enables an excessive rise in temperature outside the paper passage width to be surely prevented, and good fixing capability to be realized, together with a heating roller used therein, and an image forming apparatus using this.

### Means for Solving the Problems

A fixing apparatus of the present invention has a configuration that includes: a heat-producing element that is composed of a temperature sensitive magnetic material that becomes basically nonmagnetic at or above a predetermined temperature, and extends across the entire width of a recording material; an exciting section provided with an exciting coil that performs excitation heating of the entire width orthogonal to the feeding direction of the recording material opposite the heat-producing element; and a pressure section for bringing heat generated by the heat-producing element into contact with the recording material; wherein Curie temperature Tc of the temperature sensitive magnetic material is made 220° C. or lower, and the fixing set temperature of the heat-producing element corresponding to a part where the recording material passes during continuous paper feeding is set to a value lower than temperature Ts at which the relative magnetic permeability of the temperature sensitive magnetic material begins to fall.

A heating roller according to the present invention is an induction heating roller that is composed of a temperature sensitive magnetic material that becomes basically nonmagnetic at or above a predetermined temperature, and is used in a fixing apparatus in which Curie temperature Tc of the temperature sensitive magnetic material is made 220° C. or lower, and temperature Ts at which the relative magnetic permeability of the temperature sensitive magnetic material begins to fall is set to a temperature higher than the fixing temperature.

That is to say, according to one aspect of the present invention, a fixing apparatus has a configuration that includes: an exciting section that forms a surrounding magnetic field when a voltage is applied; a heat-producing section that produces heat by causing magnetic flux generated in the magnetic field to penetrate inside; and a fixing section that heat-fixes an image temporarily formed on a recording material using heat generated by the heat-producing section; wherein the heat-producing section is composed of a temperature sensitive magnetic material that is a magnetic material whose Curie temperature at which magnetism disappears when a predetermined temperature or higher is reached has been adjusted, and has undergone annealing treatment at 600° C. or higher after shaping processing as an endless belt, roller, or the like of uniform thickness, and an electrically conductive permeable conductive layer in which an induction current is generated internally by penetration of the magnetic flux undergoes annealing treatment after the shaping processing.

Consequently, the fall in the relative magnetic permeability of the temperature sensitive magnetic material in the vicinity of the Curie temperature is small when a rise in temperature occurs due to the penetration of alternating magnetic flux, enabling the occurrence of offset to be prevented and good, high-speed fixing to be realized, while realizing a rapid rise in temperature and preventing an excessive rise in temperature in the fixing apparatus.

According to another aspect of the present invention, a fixing apparatus has a configuration that includes: a heat-producing element that spans the entire width of recording material including temperature sensitive magnetic material that becomes basically nonmagnetic at or above a predetermined temperature; an exciting section provided with an exciting coil that performs excitation heating of the entire width orthogonal to the feeding direction of recording material opposite the heat-producing element; and a pressure section for bringing heat generated by the heat-producing element into contact with recording material; and Curie temperature Tc of the temperature sensitive magnetic material is made 220° C. or lower, and the fixing set temperature of the heat-producing element corresponding to a part where recording material passes during continuous paper feeding is set to a value lower than temperature Ts at which the relative magnetic permeability of the temperature sensitive magnetic material begins to fall.

It is desirable for Curie temperature Tc of the temperature sensitive magnetic material and temperature Ts at which the relative magnetic permeability of the temperature sensitive magnetic material begins to fall to be set so that Tc−Ts≦30° C.

It is also desirable for the heat-producing element to have a laminated configuration in which a nonmagnetic electrically conductive layer is provided on the exciting coil side of the temperature sensitive magnetic material, and the thickness of the temperature sensitive magnetic material is set to at least 0.1 mm and not more than 0.7 mm.

It is also desirable for the temperature sensitive magnetic material to be created by executing annealing treatment after a thin-walled cylindrical shape has been formed by plasticity processing of a temperature sensitive magnetic metallic material.

It is also desirable for a nonmagnetic electrical conductor to be provided opposite the exciting coil, sandwiching the heat-producing element, and to be configured so that, due to a rise in temperature and fall in magnetic permeability of the heat-producing element, magnetic flux formed by the exciting section passes through the heat-producing element and penetrates the interior of the nonmagnetic electrical conductor.

It is also desirable for the fixing apparatus to have a belt fixing unit configuration provided with an endless fixing belt that is in contact with and suspended on the outer periphery of the temperature sensitive magnetic material, is in contact with the pressure section, and supplies heat to the recording material while gripping and transporting the recording material.

It is also desirable to use a configuration in which the temperature sensitive magnetic material is a non-rotating member, and the fixing belt moves around, sliding in contact with this temperature sensitive magnetic material.

It is also desirable to use a configuration in which the fixing belt has an electrically conductive heat-producing layer that produces heat itself by the exciting section, and the temperature sensitive magnetic material is a magnetic path forming section that does not produce heat itself.

It is also desirable for the fixing apparatus to have a configuration that includes a fixing temperature detection section that detects the temperature of the heat-producing element corresponding to a part where recording paper passes, and a control section that controls power supply to the exciting section based on detection information of the fixing temperature detection section; wherein, by the control section, the fixing temperature of a part where the recording paper passes is controlled at a constant temperature, and the temperature outside the recording paper width is auto-temperature-controlled at a temperature between temperature Ts at which the relative magnetic permeability of the temperature sensitive magnetic material begins to fall and Curie temperature Tc of the temperature sensitive magnetic material.

It is also desirable for the induction heating roller to be composed of a temperature sensitive magnetic material that becomes basically nonmagnetic at or above a predetermined temperature, for Curie temperature Tc of the temperature sensitive magnetic material to be 220° C. or lower, for temperature Ts at which the relative magnetic permeability of the temperature sensitive magnetic material begins to fall to be set to a temperature higher than the fixing temperature, and for Curie temperature Tc of the temperature sensitive magnetic material and temperature Ts at which the relative magnetic permeability of the temperature sensitive magnetic material begins to fall to be set so that Tc−Ts≦30° C.

According to these configurations, the temperature of the fixing roller or fixing belt does not rise much above 220° C., an excessive rise in temperature outside the paper passage width can be surely prevented, and neither shortening of the life of rubber material nor bearing damage occurs. Also, since the relative magnetic permeability of the heat-producing element can be maintained at a high level up to the vicinity of the temperature to be limited, heat production efficiency during fixing is good, there is no fall in the calorific value in the vicinity of the fixing temperature during warm-up resulting in a longer warm-up time, and an easy-to-use fixing apparatus can be realized that combines a short warm-up time with prevention of an excessive rise in temperature outside the paper passage width.

### ADVANTAGEOUS EFFECT OF THE INVENTION

According to the present invention, by using a magnetic material whose Curie temperature at which magnetism disappears when a predetermined temperature or higher is reached has been adjusted, and that has undergone annealing treatment at 600° C. or higher after shaping processing as an endless belt, roller, or the like of uniform thickness, an excessive rise in temperature and the occurrence of offset can be prevented, and good fixing capability can be realized, in an electromagnetic heating type of fixing apparatus.

Also, according to the present invention, an excessive rise in temperature when narrow recording material is fed through continuously is surely prevented, and the warm-up time is shortened, and furthermore shortening of the fixing apparatus life, the occurrence of offset, and so forth, due to an excessive rise in temperature can be prevented, and good fixing capability can be realized.

### BRIEF DESCRIPTION OF DRAWINGS

FIG. 1 is a graph showing time variation of the surface temperature of a fixing roller in a fixing apparatus according to Embodiment 1 of the present invention;

FIG. 2 is a cross-sectional drawing showing a configuration of a fixing apparatus according to Embodiment 1 of the present invention;

FIG. 3 is a cross-sectional drawing showing another configuration of a fixing apparatus according to Embodiment 1 of the present invention;

FIG. 4 is a cross-sectional drawing showing yet another configuration of a fixing apparatus according to Embodiment 1 of the present invention;

FIG. 5 is a cross-sectional drawing showing yet another configuration of a fixing apparatus according to Embodiment 1 of the present invention;

FIG. 6 is a cross-sectional drawing showing yet another configuration of a fixing apparatus according to Embodiment 1 of the present invention;

FIG. 7 is a cross-sectional drawing showing the schematic configuration of an image forming apparatus that uses a fixing apparatus according to Embodiment 2 of the present invention;

FIG. 8 is a cross-sectional drawing showing a fixing apparatus according to Embodiment 2 of the present invention;

FIG. 9 is a cross-sectional drawing showing the fixing belt in a fixing apparatus according to Embodiment 2 of the present invention;

FIG. 10 is a cross-sectional drawing showing the exciting coil in a fixing apparatus according to Embodiment 2 of the present invention;

FIG. 11 is a principal-part enlarged view for explaining the heat-producing section in a fixing apparatus according to Embodiment 2 of the present invention;

FIG. 12 is a graph showing temperature distribution of the fixing belt during continuous paper feeding in Embodiment 2 of the present invention;

FIG. 13 is a graph showing the relative magnetic permeability/temperature characteristic of temperature sensitive magnetic material in Embodiment 2 of the present invention;

FIG. 14 is a graph showing the relative magnetic permeability/temperature characteristic of temperature sensitive magnetic material before annealing treatment in Embodiment 2 of the present invention;

FIG. 15 is a graph showing temperature rise characteristics of the fixing belt during warm-up in Embodiment 2 of the present invention;

FIG. 16 is across-sectional drawing showing a fixing apparatus according to Embodiment 3 of the present invention;

FIG. 17 is a cross-sectional drawing showing a fixing apparatus according to Embodiment 4 of the present invention;

FIG. 18 is a cross-sectional drawing showing a fixing apparatus according to Embodiment 5 of the present invention; and

FIG. 19 is an axial-direction cross-sectional drawing showing the fixing roller section in a fixing apparatus according to Embodiment 5 of the present invention.

### BEST MODE FOR CARRYING OUT THE INVENTION

Embodiments of the present invention will now be described in detail with reference to the accompanying drawings.

### Embodiment 1

FIG. 1 is a graph showing time variation of the surface temperature of a fixing roller in a fixing apparatus according to Embodiment 1 of the present invention, and shows time variation of the fixing roller surface temperature when caused to produce heat using a temperature sensitive magnetic metal in an electromagnetic heating type of fixing apparatus.

When heat production is performed in an electromagnetic heating type of fixing apparatus using a temperature sensitive magnetic metal, heat is generated as Joule heat due to an induction current (eddy current) generated inside the metal by the penetration of magnetic flux, and the electrical resistance of the temperature sensitive magnetic metal as an electrical conductor. Therefore, in order to heat the temperature sensitive magnetic metallic material uniformly, on the one hand it is necessary to make the electrical resistance value uniform, and for this purpose the thickness of the temperature sensitive magnetic metallic material must be made uniform since it has a fixed resistance value, while on the other hand the shape of the temperature sensitive magnetic metallic material must be made a discontinuous shape that inhibits eddy currents generated internally, or an endless shape that does not form a constituently modified layer.

The present invention lies in the discovery that, when a temperature sensitive magnetic material having a Curie temperature produces heat due to an alternating electromagnetic field, it is possible to recover from degradation of the intrinsic characteristics of the temperature sensitive magnetic material—namely, sluggishness of variation of magnetic properties in response to temperature variation in the vicinity of the Curie temperature—by performing heat treatment such as annealing after shaping processing as an endless belt, roller, or the like of uniform thickness.

That is to say, while performing magnetic annealing is known for improving the magnetic properties of a soft magnetic material, it is necessary for this to be performed at 1050 to 1100° C. for permalloy, and at 900 to 950° C. for iron or ferrosilicon.

However, in an electromagnetic heating type of fixing apparatus, it is necessary keep the thermal capacity low in order to increase the speed of a rise in temperature, and therefore a heat-producing section and heat maintaining member are made light and thin. Consequently, when magnetic annealing is performed at the above temperatures, a light and thin belt or roller is deformed, and therefore execution of such magnetic annealing is difficult.

In this embodiment, annealing treatment is performed at a temperature lower than a magnetic annealing temperature. Specifically, heat treatment such as annealing is performed for one hour at 600 to 1100° C., and preferably at 800° C. or above. An alloy of Fe and Ni, or an alloy of Fe, Ni, and Cr, for example, is used as a temperature sensitive magnetic material.

Adjusting the temperature sensitive magnetic material to a desired Curie temperature can be achieved by varying the proportions of an above-mentioned alloy. In the case of an image forming apparatus such as a copier, facsimile machine, or printer, the temperature necessary for toner fixing is generally set to between 160 and 230° C., and in the case of an alloy of Fe and Ni, an Ni percentage content of roughly 35±5% is used.

Next, an endless belt or roller of uniform thickness is fabricated using a temperature sensitive magnetic material adjusted to the above composition. When only a temperature sensitive magnetic material is used, the processing method is to carry out the above fabrication by welding rolled sheet material, then performing drawing one or more times by a die, or by performing only drawing by a die one or more times.

In order to increase magnetic heat production efficiency at a low temperature not exceeding the Curie temperature, plating, metallizing, welding, electrodeposition, vapor deposition, or processing with a cladding material is performed on the outer peripheral surface of the permeable electrically conductive layer composed of a temperature sensitive magnetic material. As a result, magnetic coupling is better than when the permeable electrically conductive layer is excited alone, and magnetic heat production efficiency improves. Specifically, Cu, Ag, Al, Au, At, or the like, preferably with a specific resistance of about 10×10⁻⁶ Ωcm, is provided as an electrically conductive nonmagnetic conductive layer on the permeable electrically conductive layer exciting section side.

It is desirable for the thickness of the electrically conductive layer combining the permeable electrically conductive layer and the nonmagnetic electrically conductive layer to be about 2 to 30 μm. When the nonmagnetic electrically conductive layer of nonmagnetic material is laid on the permeable electrically conductive layer of temperature sensitive magnetic material and excitation is performed, at a low temperature not exceeding the Curie temperature magnetic coupling is better than when the permeable electrically conductive layer is excited alone, and heat production is promoted.

Next, heat treatment is performed on material that has been shaped to the desired size by drawing or the like. A desirable atmosphere when performing heat treatment is a vacuum of 0.1 mmT or less, a nitrogen, argon, or suchlike inert gas atmosphere, or a reduced atmosphere containing hydrogen or the like.

In this embodiment, the above material was recovered by performing hydrogen gas replacement, then allowing a temperature of 800° C. to be reached in a reduced-pressure atmosphere of 0.1 mmT or less, maintaining that temperature for one hour, and then cooling the material to 200° C. or below. An effect could not be achieved dependably at a treatment temperature of 500° C. or below.

The recovered material is then made to produce heat using a fixing apparatus that transfers a printing material such as toner to a recording material such as recording paper, directly or using a photosensitive element, in an image forming apparatus such as an electrophotographic laser printer, copier, or the like.

In FIG. 1, the curve represented by the solid line indicated by reference code 1 shows the temperature rise curve of a temperature sensitive magnetic material that has undergone annealing treatment, and the curve represented by the dashed line indicated by reference code 2 shows the temperature rise curve of a temperature sensitive magnetic material that has not undergone annealing treatment. FIG. 1 is a graph comparing the respective characteristic curves.

As shown in FIG. 1, when heat production is performed using a temperature sensitive magnetic metal in an electromagnetic heating type of fixing apparatus, when the above annealing treatment has not been performed (curve 2), the set temperature is not reached after the elapse of 60 seconds, and magnetic properties gradually decline in the vicinity of the Curie temperature, whereas with a material created in this embodiment—that is, when the above annealing treatment has been performed (curve 1)—the set temperature of 170° C. is reached rapidly, in approximately 25 seconds.

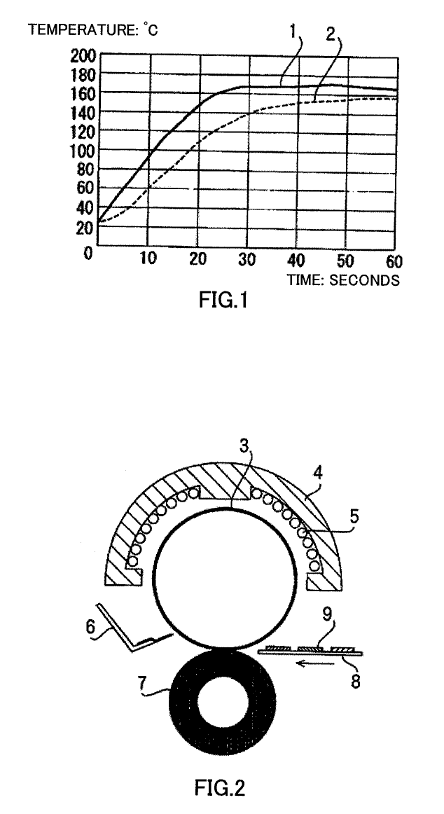

FIG. 2 through FIG. 6 are cross-sectional drawings showing configurations of fixing apparatuses according to Embodiment 1 of the present invention. Here, by way of example, fixing apparatuses will be described that transfer a printing material such as toner to a recording material such as recording paper, directly or using a photosensitive element, and fix this by applying heat and pressure, when a heating roller (and/or heating belt) is applied to an electrophotographic image forming apparatus such as a laser printer, copier, or the like.

The fixing apparatus shown in FIG. 2 radiates high-frequency magnetic flux (a high-frequency alternating magnetic field), generated by an IH (induction heating) coil 5 serving as a heat production source, onto a heat-producing roller 3, which is a heat-producing element that performs induction heat production, by controlling a magnetic circuit efficiently by an IH magnetic core 4. The radiated alternating magnetic field penetrates the interior of the temperature sensitive magnetic material of heat-producing roller 3.

At this time, at or below the Curie temperature, an eddy current is generated by magnetic flux penetrating the temperature sensitive magnetic material due to the high-frequency alternating magnetic field, and heat-producing roller 3 produces heat by Joule heat due to this eddy current. The fixing apparatus in FIG. 2 has a configuration in which a printing material 9 such as toner is heated and compressed by the heat generated by this heat-producing roller 3.

At this time, heat-producing roller 3 is configured as an integral unit with a resin layer covering. In the case of an electrophotographic image forming apparatus (laser printer, copier, or the like) that applies heat and pressure to printing material 9, fluororubber, fluororesin, or a similar heat-resistant resin or other rubber may be used as the outermost resin layer to achieve releasability with respect to printing material 9. To improve wear-resistance and releasability, it is desirable for the outer peripheral surface of heat-producing roller 3 to be covered with resin or rubber such as PTFE, PFA, or FEP, alone or mixed.

Also, to improve releasability with respect to printing material 9, it is desirable for a flexible layer having a heat storage action to be formed of a low-hardness material such as silicone rubber, for example, between the resin of the outermost layer and heat-producing roller 3.

On the other hand, a pressure roller 7 is configured as an integral unit with a resin layer covering its axial core. The resin layer of pressure roller 7 is formed, for example, of a material with low thermal conductivity such as silicone rubber with a hardness of JISA 30 degrees.

Fluororubber, fluororesin, or a similar heat-resistant resin or other rubber, for example, may be used as the material of pressure roller 7. To improve wear-resistance and releasability, it is desirable for the outer peripheral surface of pressure roller 7 to be covered with resin or rubber such as PTFE, PFA, or FEP, alone or mixed.

Also, for pressure roller 7, since it is necessary for not only heat but also pressure to be applied to a recording material 8 such as recording paper and printing material 9 thereupon, it is possible to use iron or an iron alloy, stainless steel or aluminum, or an alloy of these, as a metallic material having mechanical rigidity, or a PEEK material or phenolic resin as a high-rigidity resin, or a composite material using glass fiber or carbon fiber as a reinforcing material. With these materials, energy loss can be greatly improved by using a hollow pipe shape and/or a resin composite material with excellent thermal insulation properties in order to lower the thermal capacity.

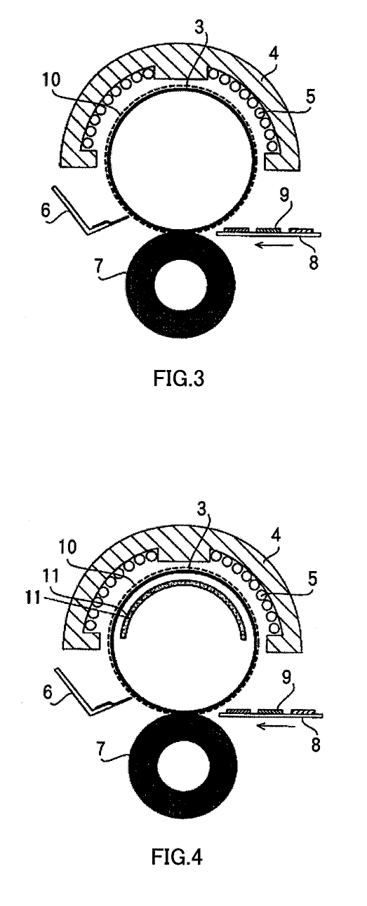

The fixing apparatus shown in FIG. 3 has an electrically conductive nonmagnetic layer 10 on the outer layer side of heat-producing roller 3, which is a heat-producing element that performs induction heat production.

This fixing apparatus, in the same way as the fixing apparatus shown in FIG. 2, radiates high-frequency magnetic flux (a high-frequency alternating magnetic field), generated by IH coil 5 serving as a heat production source, onto heat-producing roller 3, which is a heat-producing element that performs induction heat production, by controlling a magnetic circuit efficiently by an IH magnetic core 4. The radiated alternating magnetic field penetrates the interior of the temperature sensitive magnetic material of heat-producing roller 3.

At this time, at or below the Curie temperature, an eddy current is generated by magnetic flux penetrating the temperature sensitive magnetic material due to the high-frequency alternating magnetic field, and heat-producing roller 3 produces heat by Joule heat due to this eddy current. If, at this time, a temperature sensitive magnetic metal with a specific resistance of 70×10⁻⁶ Ωcm (ohm centimeters) is induction-heated by an eddy current with a frequency of 25 kHz (kilohertz), for example, the skin resistance of the temperature sensitive magnetic metal is 37×10⁻⁴ to 45×10⁻⁴Ω (ohms).

As this value is greater than the 9.8×10⁻⁴Ω skin resistance of easily induction-heated iron, and inductance is also large, in this state an eddy current tends not to flow, and the calorific value is small. However, due to the presence of electrically conductive nonmagnetic layer 10 using Cu, Ag, Al, Au, At, or the like with a specific resistance of about 10×10⁻⁶ Ωcm around the outer peripheral surface of heat-producing roller 3, the resistance value of heat-producing roller 3 falls, and heat production efficiency can be increased. It is desirable for the thickness of electrically conductive nonmagnetic layer 10 to be around 2 to 30 μm.

The fixing apparatus shown in FIG. 4 has an electrically conductive nonmagnetic plate 11 on the inner layer side of heat-producing roller 3, which is a heat-producing element that performs induction heat production.

This fixing apparatus, in the same way as the fixing apparatuses shown in FIG. 2 and FIG. 3, radiates a high-frequency electromagnetic wave (alternating magnetic field), generated by IH coil 5 serving as a heat production source, onto heat-producing roller 3, which is a heat-producing element that performs induction heat production, by controlling a magnetic circuit efficiently by an IH magnetic core 4. The radiated alternating magnetic field penetrates the interior of the temperature sensitive magnetic material of heat-producing roller 3. At this time, at or below the Curie temperature, an eddy current is generated by magnetic flux penetrating the temperature sensitive magnetic material due to the high-frequency alternating magnetic field, and heat-producing roller 3 produces heat by Joule heat due to this eddy current. When heat-producing roller 3 finally reaches its Curie temperature through heat production, its relative magnetic permeability falls, and magnetic flux resulting from the high-frequency alternating magnetic field passes through heat-producing roller 3.

When heat-producing roller 3 is thin, an eddy current generated by magnetic flux passing through in the thickness direction is constant, and therefore the current value also becomes large. Therefore, heat production by Joule heat continues.

However, when electrically conductive nonmagnetic plate 11 is positioned as shown in FIG. 4 so that heat-producing roller 3 is sandwiched between electrically conductive nonmagnetic plate 11 and the high-frequency electromagnetic wave generation area, magnetic flux that has passed through generates an eddy current in electrically conductive nonmagnetic plate 11, and magnetic flux is generated that counteracts the magnetic flux that has passed through. As the generated magnetic flux counteracts magnetic flux that has passed through heat-producing roller 3, continuation of heat production is suppressed, and temperature control can be implemented.

Although electrically conductive nonmagnetic plate 11 may be formed on the inner side of heat-producing roller 3, in order to lower the thermal capacity of heat-producing roller 3 and shorten the temperature rise time, it is desirable for there to be a space (air gap) between electrically conductive nonmagnetic plate 11 and heat-producing roller 3 as shown in FIG. 4.

The fixing apparatus shown in FIG. 5 has an electrically conductive nonmagnetic plate 11 and an internal roller comprising a thermal insulation layer 13 and an axial core 12 on the inner layer side of heat-producing roller 3, which is a heat-producing element that performs induction heat production.

This fixing apparatus, in the same way as the fixing apparatuses shown in FIG. 2 through FIG. 4, radiates a high-frequency electromagnetic wave (alternating magnetic field), generated by IH coil 5 serving as a heat production source, onto heat-producing roller 3, which is a heat-producing element that performs induction heat production, by controlling a magnetic circuit efficiently by an IH magnetic core 4. The radiated alternating magnetic field penetrates the interior of the temperature sensitive magnetic material of heat-producing roller 3.

This fixing apparatus has a configuration in which, at this time, at or below the Curie temperature, an eddy current is generated by magnetic flux penetrating the temperature sensitive magnetic material due to the high-frequency alternating magnetic field, heat-producing roller 3 produces heat by Joule heat due to this eddy current, and printing material 9 is heated and compressed by this heat.

When an increase in pressure is initiated at this time, if heat-producing roller 3 is thin the application of pressure cannot be performed uniformly. Thus, uniform pressure application can be achieved by applying pressure by a second pressure roller comprising thermal insulation layer 13 and axial core 12 installed on the inner layer side of heat-producing roller 3.

Due to the need to apply high pressure, the material used for axial core 12 of the above-described internal roller may be iron or an iron alloy, stainless steel or aluminum, or an alloy of these, as a metallic material having mechanical rigidity, or a PEEK material or phenolic resin as a high-rigidity resin, or a composite material using glass fiber or carbon fiber as a reinforcing material. With these materials, energy loss can be greatly improved by using a hollow pipe shape and/or a resin composite material with excellent thermal insulation properties in order to lower the thermal capacity.

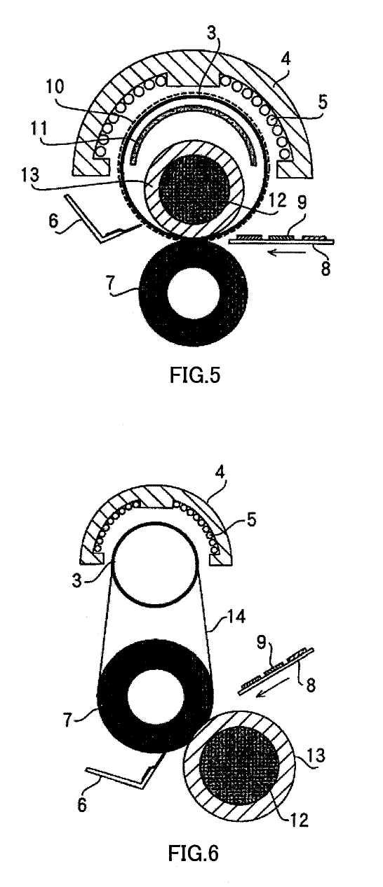

In order to further shorten the warm-up time while preventing an excessive rise in temperature, the fixing apparatus shown in FIG. 6 has a configuration in which a heat-producing belt 14 is suspended between heat-producing roller 3, which is a heat-producing element that performs induction heat production, and pressure roller 7, and a second pressure roller comprising thermal insulation layer 13 and axial core 12 is installed on the outer side of heat-producing roller 3.

According to the configuration in FIG. 6, making heat-producing roller 3 smaller in diameter enables its thermal capacity to be reduced, and also enables IH magnetic core 4 and IH coil 5 to be made smaller, making it possible for the fixing apparatus to be reduced in size.

The use of Ni or Fe as a magnetic material for heat-producing belt 14 is effective in increasing heat production efficiency, but nonmagnetic stainless steel can also be used. When an above-mentioned magnetic metallic material is used as the base material of heat-producing belt 14, the resistance value of heat-producing belt 14 can be lowered, and its heat production efficiency increased, by the presence of an electrically conductive nonmagnetic layer such as Cu, Ag, Al, Au, At, or the like with a specific resistance of about 10×10⁻⁶ Ωcm in close contact with the belt base material.

A heat-resistant polyimide resin can also be used as the base material of heat-producing belt 14. When a resin belt is used, electromagnetic properties are desirable, and through the addition of an electrically conductive material such as Ag, Al, Au, At, or the like to provide electrical conductivity, when a radiated high-frequency electromagnetic wave (alternating magnetic field) passes through heat-producing belt 14, an eddy current is generated by magnetic flux, and heat-producing belt 14 also produces heat by Joule heat due to this eddy current, enabling heat production efficiency to be increased. Fluororubber, fluororesin, or a similar heat-resistant resin or other rubber, for example, may be used for the outermost layer of heat-producing belt 14.

To improve wear-resistance and releasability, it is desirable for the outer peripheral surface of heat-producing belt 14 to be covered with resin or rubber such as PTFE, PFA, or FEP, alone or mixed. Also, to improve releasability with respect to printing material 9, it is desirable for a flexible layer having a heat storage action to be formed of a low-hardness material such as silicone rubber, for example, between the resin of the outermost layer and the base material.

### Embodiment 2

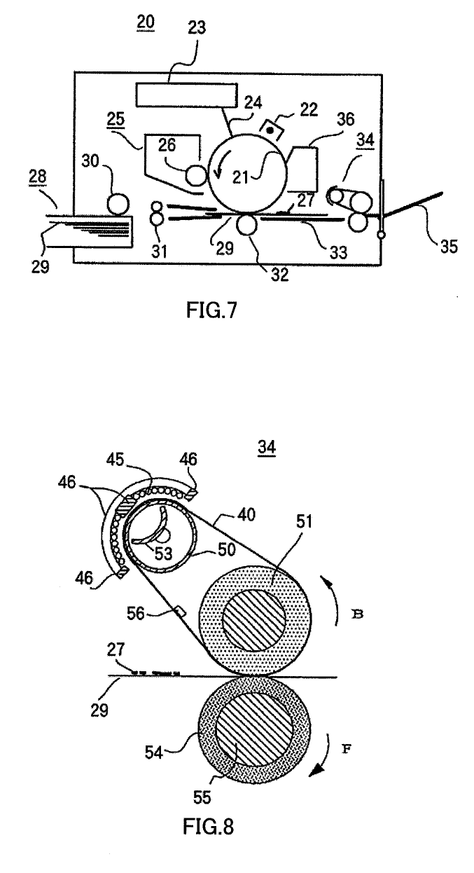

FIG. 7 is a cross-sectional drawing showing the schematic configuration of an image forming apparatus that uses a fixing apparatus according to Embodiment 2 of the present invention.

As shown in FIG. 7, an electrophotographic photosensitive body (hereinafter referred to as “photosensitive drum”) 21 is mounted in a freely rotatable fashion in an image forming apparatus body 20 of this image forming apparatus. Photosensitive drum 21 is rotated at a predetermined circumferential speed in the direction indicated by the arrow while its surface is uniformly charged to a negative predetermined dark potential V0 by an electrifier 22.

A laser beam scanner 23 outputs a laser beam 24 modulated in accordance with a time series electrical digital pixel signal of image information input from a host apparatus such as an image reading apparatus or computer (not shown).

The uniformly charged surface of photosensitive drum 21 is exposed by scanning by laser beam 24. By this means, the absolute value of the potential of exposed parts of photosensitive drum 21 falls and becomes a light potential VL, and an electrostatic latent image is formed on the surface of photosensitive drum 21. This electrostatic latent image undergoes reversal development by negatively charged toner of a developing unit 25, and is developed (made a toner image).

Developing unit 25 is provided with a rotated developing roller 26. Developing roller 26 is positioned opposite photosensitive drum 21, and a thin layer of toner is formed on its outer peripheral surface. A developing bias voltage with an absolute value smaller than dark potential V0 of photosensitive drum 21 and larger than light potential VL is applied to developing roller 26. By this means, the toner on developing roller 26 is transferred only to light potential VL parts of photosensitive drum 21, an electrostatic latent image is developed, and an unfixed toner image (hereinafter referred to simply as “toner image”) 27 is formed on photosensitive drum 21.

Meanwhile, recording paper 29 is fed by a paper feed roller 30 as a recording medium one sheet at a time from a paper feed section 28. Fed recording paper 29 is transported through a pair of registration rollers 31 to the nip between photosensitive drum 21 and transfer roller 32 at appropriate timing synchronized with the rotation of photosensitive drum 21. By this means, toner image 27 on photosensitive drum 21 is transferred to recording paper 29 by a transfer roller 32 to which a transfer bias is applied.

Recording paper 29 on which toner image 27 is formed and held in this way is guided by a recording paper guide 33 and separated from photosensitive drum 21, and then transported toward the fixing area of a heat-fixing apparatus (hereinafter referred to simply as “fixing apparatus”) 34. Once transported to this fixing area, recording paper 29 has toner image 27 heat-fixed onto it by fixing apparatus 34.

After passing through fixing apparatus 34, recording paper 29 onto which toner image 27 has been heat-fixed is ejected onto an output tray 35 attached to the outside of image forming apparatus body 20. After recording paper 29 has been separated from photosensitive drum 21, photosensitive drum 21 has residual material such as untransferred toner remaining on its surface removed by a cleaning apparatus 36, and is made ready for the next image forming operation.

FIG. 8 is a cross-sectional drawing showing the configuration of a fixing apparatus according to Embodiment 2 of the present invention.

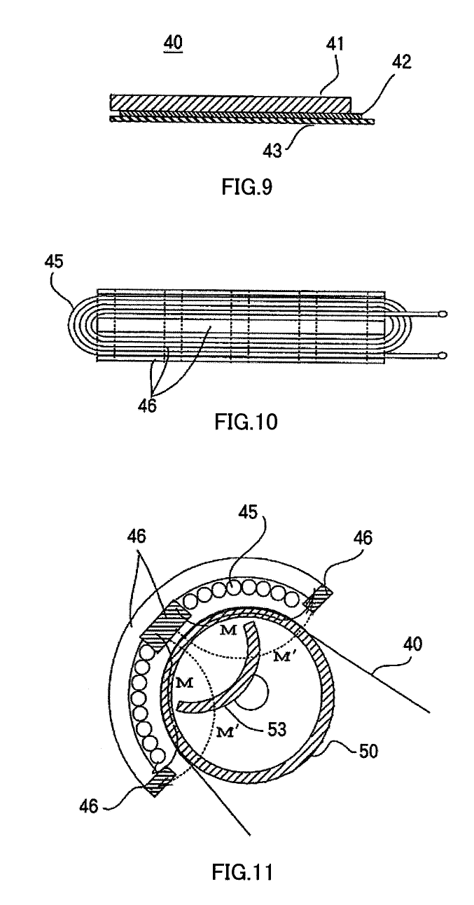

A thin fixing belt 40 is an endless belt with a base material 41 of polyimide resin, and for A3 recording use is approximately 340 mm wide, 47 mm in diameter, and 70 μm thick. A cross-sectional view of this fixing belt 40 is shown in FIG. 9. As shown in FIG. 9, an electrically conductive layer 42 of copper material approximately 10 μm thick is formed on base material 41 as a layer that produces heat by electromagnetic induction. Also, the surface of electrically conductive layer 42 is covered with a 25 μm thick release layer 43 of fluororesin to provide releasability with respect to a toner image.

Electrically conductive layer 42 may also be formed by coating the resin base material with an electrically conductive layer in which a low-resistance powdered material such as silver is dispersed. Very thin metal such as electroformed nickel with a thickness of approximately 40 μm can also be used as the material of base material 41. In this case, above-described electrically conductive layer 42 may be omitted since nickel has a heat-producing function. A metal other than nickel can be used as a metallic base material, such as iron or stainless steel, a cobalt-nickel alloy, or a nickel-iron alloy, but with a nonmagnetic SUS material it is desirable for an electrically conductive layer 42 of copper material to be formed as described above.

Surface release layer 43 may be formed by a coating of resin or rubber with good releasability such as PTFE, PFA, FEP, silicone rubber, fluororubber, or the like, alone or mixed. For monochrome image fixing it is sufficient to secure releasability, but for color image fixing it is desirable for elasticity to be provided, and in this case it is necessary to form a fairly thick (100 to 300 μm) rubber layer on the under-layer of release layer 43.

Reference code 45 indicates an exciting coil serving as an exciting section. This exciting coil 45 uses litz wire comprising bundled thin wires, and as shown in FIG. 8, its cross-sectional shape is formed as a semicircle so as to cover fixing belt 40, and a core 46 of ferrite is provided in the center and on part of the rear. A high-permeability material such as permalloy can also be used for core 46. FIG. 10 is a cross-sectional drawing showing the configuration of core 46 and exciting coil 45 viewed from fixing belt 40. As shown in FIG. 10, exciting coil 45 is formed along central core 46 over almost the entire length of heat-producing roller 50, and rear core 46 is only partially present, configured so as to trap magnetic flux leaking outside. Maximum power of about 1200 W is applied to exciting coil 45 by an alternating current of 20 to 60 kHz from an exciting circuit (not shown).

Next, a fixing apparatus of this embodiment will be described in detail.

Returning to FIG. 8, fixing belt 40 is suspended at predetermined tension between a 34 mm diameter fixing roller 51 with low thermal conductivity, made of silicone rubber, an elastic foam material with low surface hardness (JISA 30 degrees), and a 20 mm diameter heat-producing roller 50 made of an alloy described later herein, and can rotate in the direction indicated by arrow B in the figure.

Heat-producing roller 50 is made of 0.2 mm thick temperature sensitive magnetic metal comprising a nickel-iron alloy. Heat-producing roller 50 is fabricated with the constituent proportions of iron and nickel adjusted so that its relative magnetic permeability/temperature characteristic is the temperature characteristic shown in FIG. 13. The temperature sensitive magnetic alloy of this embodiment has a nickel proportion of 30+%. As shown in FIG. 13, Curie temperature Tc of this heat-producing roller 50 is 200° C., and heat-producing roller 50 shows strong magnetism at normal temperature, but its relative magnetic permeability begins to fall at 184° C. and falls sharply above 190° C., and heat-producing roller 50 becomes nonmagnetic at or above Curie temperature Tc. The relative magnetic permeability/temperature characteristic shown in FIG. 13 shows measured values under conditions of a 30 kHz alternating magnetic field with a magnetic field strength of 45 A/m.

Inside heat-producing roller 50, an arc-shaped copper plate 53 with its end surfaces facing heat-producing roller 50 is fitted across almost the entire width of heat-producing roller 50. The end surfaces of copper plate 53 are positioned opposite the approximately center parts of the left and right windings respectively of exciting coil 45, and fixed in position so as to leave a gap of approximately 0.5 mm between each end surface and heat-producing roller 50.

In FIG. 8, the surface of a pressure roller 54 is made of silicone rubber with a hardness of JISA 65 degrees. As shown in FIG. 8, pressure roller 54 forms a nip by pressing against fixing roller 51 via fixing belt 40. Pressure roller 54 is supported so as to rotate freely in this state about a metallic shaft 55. Pressure roller 54 is rotated by an apparatus body drive source (not shown) in the direction indicated by arrow F in the figure, and a fixing operation is performed by the consequent rotation in idler fashion of fixing belt 40, fixing roller 51, and heat-producing roller 50. Exciting coil 45 and copper plate 53 are both fixed, and do not move.

Another heat-resistant resin or rubber such as fluororubber or fluororesin may also be used as the material of pressure roller 54. It is also desirable for the surface of pressure roller 54 to be coated with resin or rubber such as PFA, PTFE, or FEP, alone or mixed, to increase wear resistance and releasability. Furthermore, it is desirable for pressure roller 54 to be made of a material with low thermal conductivity.

Reference code 56 indicates a temperature sensor, which is positioned approximately in the width direction center of fixing belt 40 and on the entry side of the fixing nip. This temperature sensor 56 is provided to detect the temperature of fixing belt 40, and control the paper passage area temperature constantly at a predetermined fixed temperature by a control circuit (not shown).

The operation of fixing apparatus 34 configured as described above will now be explained.

First, a fixing apparatus 34 warm-up operation will be described.

When an image forming apparatus is switched off or is in the sleep state, the temperature of heat-producing roller 50 of fixing apparatus 34 normally falls to room temperature. When power is turned on or recovery from the sleep state is performed in order to perform printing, rotation of pressure roller 54 is first started, and an exciting current is applied to exciting coil 45 while fixing belt 40, fixing roller 51, and heat-producing roller 50 are all rotating. When exciting coil 45 is energized, an eddy current is generated in the parts of electrically conductive layer 42 of fixing belt 40 and heat-producing roller 50 opposite exciting coil 45, and those parts produce heat. At this time, the control circuit continues to constantly monitor the temperature of fixing belt 40 by temperature sensor 56, and continues to energize exciting coil 45 at around full power until a target temperature is reached. Then, when the temperature of fixing belt 40 reaches a fixing temperature suitable for fixing toner image 27, the control circuit performs feedback control so as to maintain the temperature of fixing belt 40 at the fixing temperature by controlling output. In this embodiment, the fixing temperature is set at 170° C., and by applying 1200 W power to exciting coil 45, the entire A3 maximum paper width can be heated from a normal temperature of 25° C. to the fixing temperature in approximately 12 seconds.

FIG. 11 is an enlarged view of the exciting coil 45 and heat-producing roller 50 parts of fixing apparatus 34 shown in FIG. 8, showing the magnetic paths formed when exciting coil 45 is energized.

When warm-up is performed from normal temperature to the 170° C. fixing temperature, in order for heat-producing roller 50 to maintain a ferromagnetic state as shown in FIG. 13, magnetic flux generated by exciting coil 45 passes through fixing belt 40 from core 46 and enters heat-producing roller 50, passes through heat-producing roller 50 and enters core 46, and travels around exciting coil 45, as shown by solid lines M in FIG. 11. Therefore, while the temperature is rising, strong magnetic coupling is constantly obtained between exciting coil 45 and heat-producing roller 50, stable maximal heat production is obtained, and rapid warm-up is possible.

Next, the operation when continuous paper feeding is performed will be described.

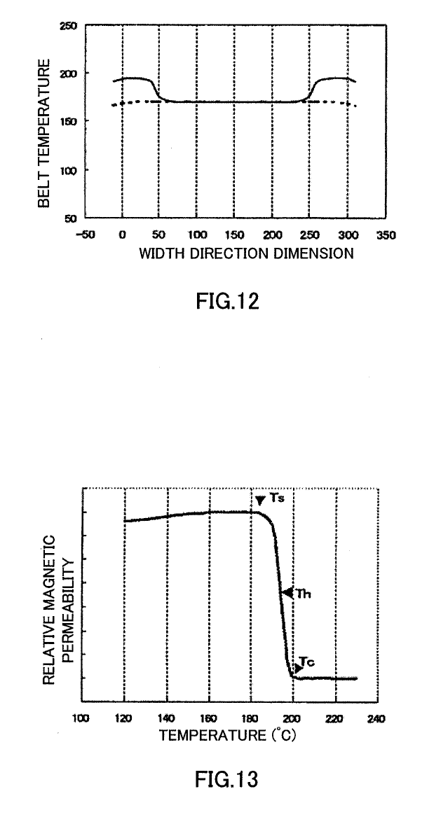

FIG. 12 is a graph showing temperature distribution in the fixing belt width direction when paper of different sizes is continuously fed through.

When maximum width paper (in this embodiment, A3 paper) is continuously fed through, the entire A3 width is maintained at a virtually uniform 170° C., as shown by the dashed line in FIG. 12. This is because the recording paper is in contact across the entire width of the fixing belt, and the entire width is constantly and uniformly cooled.

On the other hand, when smaller portrait-orientation A4 paper is continuously fed through, fixing belt 40 is controlled at a fixed temperature of 170° C. by temperature sensor 56 and the control circuit within an A4 width in contact with the paper, but outside the A4 width the paper is not in contact, and there is no cooling by the paper. As power is applied across the entire width at this time, the temperature of fixing belt 40 rises rapidly outside the A4 width.

At the same time, the temperature of areas of heat-producing roller 50 corresponding to areas beyond A4 size also rises, and approaches the Curie temperature. When the temperature of heat-producing roller 50 approaches temperature Ts at which magnetic permeability begins to change, the magnetic permeability of those parts falls rapidly and their magnetism is lost, and as a result, magnetic flux of areas outside the A4 paper width formed by exciting coil 45 changes from being as shown by solid lines M to being as shown by dashed lines M′ in FIG. 11. Magnetic flux M′ passes through heat-producing roller 50 and low-resistance copper plate 53 and travels around exciting coil 45, but is greatly attenuated on passing through copper plate 53 because a strong eddy current flows in copper plate 53.

As a result, thermal capacity per unit area of areas outside the paper width is greatly suppressed, the rise in temperature of fixing belt 40 stops at a temperature at which the heat discharge and calorific value of these areas are in balance, and an auto-temperature-control function operates, preventing an excessive rise in temperature. With this embodiment, in continuous output of 32 sheets per second, the rise in temperature of fixing belt 40 was suppressed to 195° C. as shown by the solid line in FIG. 12.

In this embodiment, only feeding of portrait-orientation A4 size paper has been shown, but it goes without saying that the paper size is not limited to this, and this principle operates, and an excessive rise in temperature outside the paper width is suppressed, with any paper size. In this case, it also goes without saying that the position of temperature sensor 56 should correspond to a location that is passed by all paper that is used.

The temperature at which auto-temperature-control operates outside the paper width is particularly influenced by the speed of continuous paper feeding and the thickness of the paper. This is because the power applied to the entire exciting coil 45 is greatly affected by these conditions, but in most cases an excessive rise in temperature can be suppressed to the Curie temperature or below, enabling a highly reliable fixing apparatus to be realized, with no shortening of the life of rubber material or occurrence of damage to bearings.

In this embodiment, copper plate 53 is installed inside heat-producing roller 50. This copper plate 53 is provided in order to generate an eddy current in a direction in which magnetic flux outside the paper width that has penetrated inside heat-producing roller 50 is attenuated, and more effectively suppress heat production outside the paper width, but the provision of copper plate 53 is not absolutely essential. Even without copperplate 53, when heat-producing roller 50 approaches a nonmagnetic state and magnetic coupling to exciting coil 45 weakens, magnetic flux of that part decreases, and heat production falls, so that an excessive rise in temperature can be effectively prevented even though the auto-temperature-controlled temperature is higher than when copper plate 53 is present.

Plate 53 is not limited to a copper material, the only requirements being the use of a material that has a low specific resistance and is susceptible to the generation of eddy currents, such as aluminum or silver, as well as ensuring a predetermined thickness, having low resistance, and not being prone to heat production.

Next, the relationship between the magnetic properties of heat-producing roller 50 used in this embodiment, the warm-up time, and the rise in temperature during continuous small-size paper feeding, will be explained.

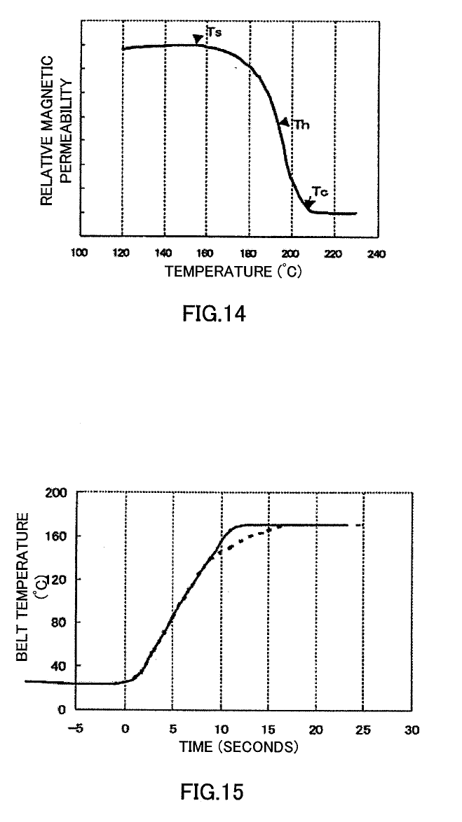

FIG. 14 is a graph showing the relative magnetic permeability/temperature characteristic before annealing treatment of heat-producing roller 50 used in this embodiment. As in the case of FIG. 13, the relative magnetic permeability/temperature characteristic shows measured values under conditions of a 30 kHz alternating magnetic field with a magnetic field strength of 45 A/m.

Here, heat-producing roller 50 was made cup-shaped by deep drawing of temperature sensitive magnetic metal comprising an approximately 1 mm thick plate, and this was made thinner by spinning, producing a pipe shape with a thickness of 0.2 mm and a length of 330 mm. The processing method is not, of course, limited to this, and methods such as annealing in which the wall of a tube is made thinner by ironing, or using a welded tube and making its wall thinner by ironing, are in practical use. Heat-producing roller 50 must be thin in order to reduce its thermal capacity, and its magnetic properties and shape must be uniform throughout. Also, since the material of heat-producing roller 50 is comparatively expensive, it is preferable not to use machining or suchlike processing, but to form the roller by molding. However, if the temperature sensitive magnetic metal is made highly mold-deformable, its magnetic properties will be greatly altered.

FIG. 14 shows the characteristic immediately after the above-mentioned spinning processing has been executed. As shown in FIG. 14, relative magnetic permeability begins to fall from the vicinity of 158° C. indicated by Ts, and the roller becomes virtually nonmagnetic at Curie temperature Tc=212° C. Value Th at which relative magnetic permeability has decreased by 50% is 196° C. Heat-producing roller 50 of this embodiment is subjected to annealing treatment in which, directly after the above-described processing, heat-producing roller 50 is kept at 800° C. in a nitrogen gas atmosphere for one hour, and then cooled to 200° C. or below. FIG. 13 shows the magnetic characteristic after this annealing treatment. As can be seen from a comparison with FIG. 14, after annealing treatment the change in relative magnetic permeability is more abrupt, 50% decrease value Th is 194° C., almost the same as before annealing treatment, but Curie temperature Tc is 200° C., and temperature Ts at which relative magnetic permeability begins to fall is 184° C.

It is desirable for annealing treatment to be carried out for one hour at 600 to 1100° C., and preferably at 800° C. or above, and for the treatment atmosphere to be a vacuum of 0.1 mmT or less, a nitrogen, argon, or suchlike inert gas atmosphere, or a reduced atmosphere containing hydrogen or the like. An effect could not be achieved dependably at a treatment temperature of 500° C. or below.

It goes without saying that the Curie temperature can be adjusted to a desired temperature by varying the proportions of Fe and Ni in the alloy.

A comparison of warm-up times when using a heat-producing roller before and after this annealing treatment is shown in FIG. 15.

In FIG. 15, a fixing belt warm-up characteristic when a heat-producing roller that had undergone annealing treatment according to the present invention was used is shown by a solid line, and a fixing belt warm-up characteristic when a heat-producing roller that had not yet undergone annealing treatment was used is shown by a dashed line. With a heat-producing roller after annealing treatment according to the present invention, as indicated by the solid line, a temperature of 170° C. was reached in 12 seconds, as described above, whereas with a heat-producing roller before annealing treatment, as indicated by the dashed line, the temperature rise curve became gentler from around 150° C., and it took approximately 17 seconds to reach 170° C. The reason for this is considered to be that, with a heat-producing roller after annealing treatment, since a change in magnetic properties appears at an early stage in the vicinity of 160° C., magnetic flux M′ passing through heat-producing roller 50 indicated by the dashed lines in FIG. 11 begins to increase from an early stage due to a strong magnetic field, the magnetic coupling between fixing belt 40 and heat-producing roller 50 and exciting coil 45 weakens, and the heat production efficiency of fixing belt 40 and heat-producing roller 50 falls. On the other hand, a heat-producing roller that has undergone annealing treatment maintains its ferromagnetic state stably even at 180° C., there is very little generation of permeating magnetic flux M′, and fixing belt 40 shows a stable temperature rise curve up to 170° C.

The results of performing continuous feeding of portrait-orientation A4 size paper using both of these were that, under the same conditions, the excessive rise in temperature outside the paper width was 195° C. or less when using heat-producing roller 50 after annealing treatment, but the temperature rose to nearly 210° C. when using a heat-producing roller prior to annealing treatment. The reasons for this are considered to be that the fact that the regulated temperature within the paper passage width is 170° C., by which time the proportion of magnetic flux M′ has already increased throughout heat-producing roller 50, and the heat production efficiency of the induction-heated parts (electrically conductive layer 42 of fixing belt 40 and heat-producing roller 50) falls, and power necessary for temperature regulation increases, and also the fact that there tends not to be such a difference between a paper passage part and paper non-passage part.

From the results of the above comparison it can be seen that, in order to shorten the warm-up time when starting up, it is better for temperature Ts at which relative magnetic permeability begins to fall, rather than the Curie temperature, to be as high as possible, and to be separated from the fixing temperature on the high-temperature side. Also, with regard to a rise in temperature outside the paper width when small-size paper is continuously fed through, its is similarly desirable for the fixing set temperature and temperature Ts at which relative magnetic permeability begins to fall to be separated, and for a change in relative magnetic permeability to occur abruptly.

Generally, a fixing apparatus is not restricted to the use of a single fixing temperature, and there are many cases in which a plurality of fixing temperature settings are made according to the thickness or type of paper used.

When thick paper or OHP sheets are output, in this embodiment, also, a temperature is set to 180° C. that is 10° C. higher than the set temperature 170° C. when ordinary paper is used (although the processing speed is often set to half-speed in this case). When a heat-producing roller with the pre-annealing characteristic shown in FIG. 14 is used under these conditions, magnetic permeability has already fallen within the paper passage area, and as a result, overall heat production efficiency is poor, and an excessive rise in temperature outside the paper width is also much greater than when the fixing temperature is set to 170° C.

In view of the above, it is desirable for temperature Ts at which relative magnetic permeability begins to fall to be set to as high a temperature as possible above the fixing temperature, but it is preferable for the Curie temperature not to be set high in line with this, as the rise in temperature outside the paper width will be excessive. Taking into consideration the upper temperature limit of the silicone rubber material used for fixing belt 40 and pressure roller 54, a temperature as far below 220° C. as possible is desirable.

By setting a Curie temperature of 220° C. or below as a magnetic property of the temperature sensitive magnetic metal used for heat-producing roller 50, using a material for which the difference between this Curie temperature and temperature Ts at which relative magnetic permeability begins to fall is preferably 30° C. or less and relative magnetic permeability changes abruptly, and setting the fixing set temperature to a temperature lower than temperature Ts at which relative magnetic permeability begins to fall, as described above, shortening of the warm-up time, securement of heating efficiency during continuous paper feeding, and suppression of an excessive rise in temperature outside the paper width can all be achieved, and shortening of the life of rubber material, damage to bearing members, and so forth can be effectively prevented.

In this embodiment, an alloy of iron and nickel is used as a temperature sensitive magnetic metal, but heat-producing roller 50 is not necessarily limited to these materials. A soft magnetic material that has a clear Curie temperature is desirable, and it is also possible to use a material that includes chromium together with iron or nickel, the insulating material MnZn ferrite, and so forth. In the case of an insulating material, the heat-producing roller itself does not produce heat, but magnetic flux passing through induction-heated electrically conductive layer 42 of fixing belt 40 can be controlled, making it possible to obtain the same kind of effects as with this embodiment. Also, in the case of an insulating material, it is important to ensure adequate contact between the fixing belt and the temperature sensitive magnetic material, and to minimize the difference in temperature between the fixing belt and the temperature sensitive magnetic material, which can be achieved by making the thermal capacity of the temperature sensitive magnetic material as small as possible. Moreover, when an insulating material is used, heat production outside the paper passage area when small-size paper is fed through continuously is further suppressed since no eddy currents are generated in the temperature sensitive magnetic material, and this is effective in preventing an excessive rise in temperature.

Furthermore, in this embodiment, induction-heated electrically conductive layer 42 is provided on fixing belt 40, but this embodiment is not limited to this, and it is also possible to use a configuration in which fixing belt 40 does not have a heat-producing function and only heat-producing roller 50 is made to produce heat, and heating is performed by transferring that heat to fixing belt 40. In this case, while depending on the thickness and thermal conductivity of the fixing belt, the paper feed speed, and so forth, the temperature of heat-producing roller 50 will be slightly higher than the temperature of fixing belt 40 because of heat transfer and supply. Therefore, with this kind of configuration, taking the difference in temperature of fixing belt 40 and heat-producing roller 50 into consideration, temperature Ts at which relative magnetic permeability begins to fall should be set to a temperature higher than the temperature of heat-producing roller 50 when fixing temperature setting is performed.

### Embodiment 3

The general configuration of an image forming apparatus according to Embodiment 3 is the same as that of Embodiment 2 shown in FIG. 7, and therefore a description thereof is omitted here. In this embodiment, only the fixing apparatus configuration differs from that of Embodiment 2.

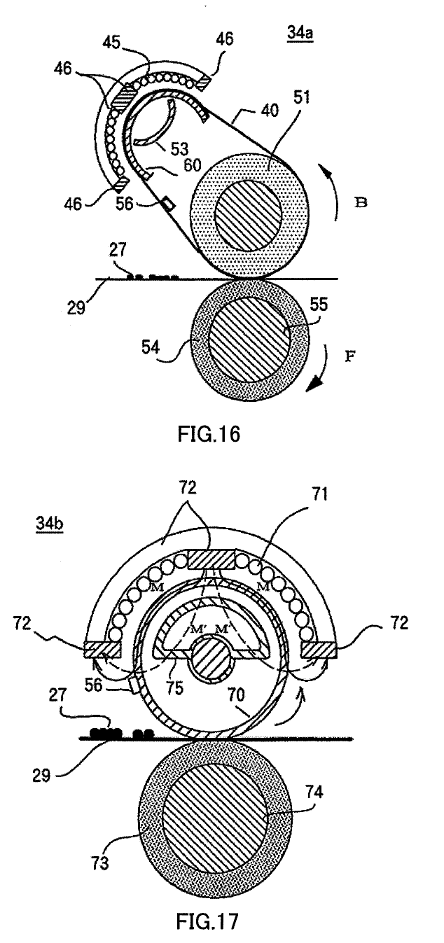

FIG. 16 is a cross-sectional drawing showing a fixing apparatus according to Embodiment 3 of the present invention. Fixing apparatus 34a of this embodiment has almost the same configuration as fixing apparatus 34 of Embodiment 2 shown in FIG. 8, but differs from fixing apparatus 34 of Embodiment 2 in that heat-producing roller 50 is replaced by a heat-producing plate 60. Configuration elements in FIG. 16 that have the same reference codes as in FIG. 8 have the same functions as in FIG. 8, and descriptions thereof are omitted here.

In FIG. 16, heat-producing plate 60 is of temperature sensitive magnetic metal comprising a nickel-iron alloy, and is a 0.3 mm thick arc-shaped plate having the same kind of magnetic properties as heat-producing roller 50 of Embodiment 2. This heat-producing plate 60 does not rotate, but is configured so as to support fixing belt 40 while being pushed away from fixing roller 51 by a spring. When pressure roller 54 rotates in this state, fixing belt 40 moves around, in contact with and rubbing against the surface of heat-producing plate 60. When exciting coil 45 is excited and magnetic flux is generated, fixing belt 40 and heat-producing plate 60 simultaneously produce heat and rise in temperature.

According to this embodiment, in addition to obtaining the effects obtained by Embodiment 2, heat-producing plate 60 having a smaller thermal capacity than a heat-producing roller is easily implemented, and the length of fixing belt 40 is also easily shortened, making it possible to further shorten the warm-up time.

### Embodiment 4

In Embodiment 4, a configuration is used in which a heat-producing roller itself is positioned opposite a pressure roller, and performs fixing by being in contact with recording paper.

The general configuration of an image forming apparatus according to this embodiment is the same as that of Embodiment 2 shown in FIG. 7, and therefore a description thereof is omitted here. In this embodiment, only the fixing apparatus configuration differs from that of Embodiment 2.

FIG. 17 is a cross-sectional drawing showing a fixing apparatus according to Embodiment 4 of the present invention.

Fixing apparatus 34b shown in FIG. 17 has a fixing roller 70. Fixing roller 70 is composed of a base material of temperature sensitive magnetic metal 360 mm wide, 40 mm in diameter, and 0.5 mm thick, covered by a 7 μm thick copper layer for promoting electromagnetic induction heat production, on the surface of which a release layer of PFA is formed. This copper layer is not absolutely essential, but forming a copper layer has the effect of enabling heat production efficiency to be increased to a greater extent than with a temperature sensitive magnetic alloy alone.

The temperature sensitive magnetic metal used in this embodiment is of the same material composition as in Embodiment 2, with plate material rounded and formed by welding, then shaped by drawing, and given a crown shape by machining its surface, after which processing, as in Embodiment 2, annealing treatment is carried out in which the roller is kept at 800° C. in a nitrogen gas atmosphere for one hour, and then cooled to 200° C. or below, as a result of which the magnetic properties shown in FIG. 13 are obtained, as in Embodiment 2.

An exciting coil 71 and core 72 serving as an exciting section are approximately analogous to exciting coil 45 and core 46 in Embodiment 2, but enlarged, and basically have the same kind of configuration.

A pressure roller 73, 40 mm in diameter and approximately 320 mm wide, is composed of silicone rubber with a hardness of JISA 65 degrees on the outside of a metal core 74, and is supported so as to rotate freely. Pressure roller 73 is pressed against fixing roller 70, and forms a fixing nip that grips the recording paper. Fixing roller 70 is supported by bearings at each end so as to be freely rotatable, and has a semilunate copper shielding plate 75 fixed in position inside. Reference code 56 indicates a temperature sensor, as in Embodiment 2. Temperature sensor 56 is in contact with the surface of fixing roller 70 and detects the temperature of fixing roller 70, and provides fixing roller 70 temperature information to a control circuit, enabling fixing roller 70 temperature control to be performed by the control circuit, in the same way as in Embodiment 2.

The operation of fixing apparatus 34b configured as described above will now be explained.

When a warm-up operation is first initiated from the standby state at normal temperature, fixing roller 70 starts to rotate in the direction indicated by the arrow in the figure, driven by a drive apparatus (not shown). At the same time, supply of a 20 to 60 kHz alternating current is started from an exciting circuit (not shown) to exciting coil 71, an induction current flows in the temperature sensitive magnetic metal and the copper layer on its surface, and fixing roller 70 begins to rise in temperature. The rotation speed of fixing roller 70 during warm-up is set slower than for a recording paper fixing operation, and a peripheral speed of 100 mm/second was used. With power input to exciting coil 71 of 1300 W, the surface temperature of fixing roller 70 reached the 175° C. fixing temperature in slightly under 20 seconds, and the warm-up operation was completed.

Then, after repeating fixing operations a number of times, 500 sheets of portrait-orientation A5 size paper were fed through at 65 sheets per minute at a paper feed speed of 360 mm/s, as a result of which the temperature of fixing roller 70 outside the paper width became saturated at 195° C.

When small-size paper is fed through continuously, the temperature outside the paper width rises steeply, but when the temperature of the temperature sensitive magnetic metal in these areas exceeds temperature Ts at which relative magnetic permeability begins to fall, in the same way as in Embodiment 2 magnetic flux formed by exciting coil 71 leaks from paths M passing through the interior of the temperature sensitive magnetic metal and permeates the temperature sensitive magnetic metal, and the proportion following paths M′ shown by the dashed lines cutting across copper shielding plate 75 increases. As a result, the proportion of heat production of fixing roller 70 outside the paper width decreases sharply, and the rise in temperature stops at a predetermined calorific value or below.

By setting a Curie temperature of 220° C. or below as a magnetic property of the temperature sensitive magnetic metal used for heat-producing roller 70, and setting the fixing set temperature to a temperature lower than temperature Ts at which relative magnetic permeability begins to fall, as described above, the relative magnetic permeability of the temperature sensitive magnetic metal does not fall during warm-up and rapid startup can be achieved, while an excessive rise in temperature outside the paper width can be suppressed during continuous paper feeding, and shortening of the life of rubber material, damage to bearing members, and so forth can also be effectively prevented.

In this embodiment, a 7 μm copper layer is provided on the outer peripheral surface of the temperature sensitive magnetic metal, the purpose of this being to increase the calorific value of fixing roller 70 and perform heating more efficiently. For example, when a temperature sensitive magnetic metal with a specific resistance of 70×10⁻⁶ Ωcm is induction-heated by an alternating current with a frequency of 25 kHz, the skin resistance of the temperature sensitive magnetic metal is 37×10⁻⁴ to 45×10⁻⁴Ω. As this value is greater than the 9.8×10⁻⁴Ω skin resistance of easily induction-heated iron, and inductance is also large, an eddy current is less prone to flow, and the calorific value is smaller, than in the case of iron. On the other hand, if an electrically conductive nonmagnetic layer using Cu, Ag, Al, Au, At, or the like with a specific resistance of about 10×10⁻⁶ Ωcm is provided on the outer peripheral surface of heat-producing roller 70, the resistance value as a heat-producing element falls, and heat production efficiency can be increased. It is desirable for the thickness of the nonmagnetic layer to be around 2 to 30 μm.

### Embodiment 5

In Embodiment 5, as in Embodiment 4, a configuration is used in which a heat-producing roller itself is positioned opposite a pressure roller, and performs fixing by being in contact with recording paper.

The general configuration of an image forming apparatus according to this embodiment is the same as that of Embodiment 2 shown in FIG. 7, and therefore a description thereof is omitted here. In this embodiment, only the fixing apparatus configuration differs from that of Embodiment 2.

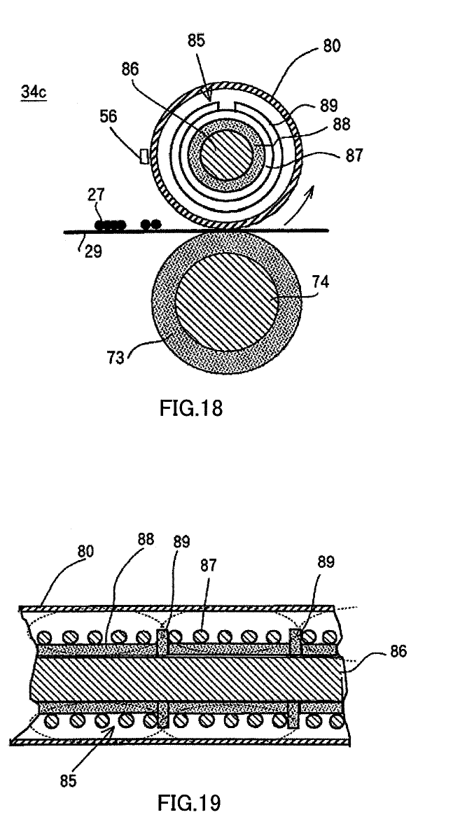

FIG. 18 is a cross-sectional drawing showing the configuration of a fixing apparatus according to Embodiment 5 of the present invention, and FIG. 19 is an axial-direction cross-sectional drawing showing the fixing roller section of the fixing apparatus in FIG. 18.

In FIG. 18 and FIG. 19, reference code 80 indicates a fixing roller. This fixing roller 80 is provided with a 5 μm thick copper layer for promoting electromagnetic induction heat production on the inner surface of a base material of temperature sensitive magnetic metal 360 mm wide, 40 mm in diameter, and 0.5 mm thick, and a release layer of PFA is formed on the outer peripheral surface of fixing roller 80.

Reference code 85 indicates an exciting coil unit. Unlike the case of Embodiment 4, this exciting coil unit 85 is installed inside fixing roller 80. Exciting coil unit 85 has core materials 88 and 89, creating a path for magnetic flux formed by an exciting coil 87, provided around a metal core 86, with exciting coil 87 of litz wire wound helically around core materials 88 and 89 in the axial direction. Exciting coil unit 85 is fitted to the fixing apparatus body independently of fixing roller 80, and does not rotate. As in Embodiment 4, reference code 56 indicates a temperature sensor, and reference code 73 a pressure roller.

With this configuration, when exciting coil 87 is energized by an exciting circuit while fixing roller 80 and pressure roller 73 are rotating, alternating magnetic flux is generated as shown by the dotted lines in FIG. 19, this alternating magnetic flux passes through the copper layer and temperature sensitive magnetic metal of fixing roller 80, and fixing roller 80 produces heat.

In this embodiment, a temperature sensitive magnetic metal having the same kind of magnetic properties as in Embodiment 2 is used for fixing roller 80, and by setting the fixing temperature, temperature sensitive magnetic metal Curie temperature Tc, and temperature Ts at which the relative magnetic permeability of the temperature sensitive magnetic metal begins to fall, all in the same way as in Embodiment 2, efficient heating and rapid warm-up can be achieved, and an effect of effectively preventing an excessive rise in temperature outside the recording paper width can be obtained.

In the present invention, if Curie temperature Tc, or temperature Ts at which relative magnetic permeability begins to fall, of a temperature sensitive magnetic material is unclear, Ts may be set to a level at which relative magnetic permeability is approximately 5% below the maximum value, and Tc may be set to a level at which relative magnetic permeability is approximately 5% above the minimum value.

The present application is based on Japanese Patent Application No. 2005-072554 filed on Mar. 15, 2005, and Japanese Patent Application No. 2005-298653 filed on Oct. 13, 2005, entire content of which is expressly incorporated herein by reference.

### INDUSTRIAL APPLICABILITY

A fixing apparatus according to the present invention can shorten the warm-up time while preventing an excessive rise in temperature, and also prevent the occurrence of offset and achieve good fixing performance, and is useful as a fixing apparatus that heat-fixes an unfixed image onto a recording material by induction heating in an image forming apparatus such as a copier, facsimile machine, or printer.

Also, a fixing apparatus according to the present invention heat-fixes an unfixed image onto a recording material by induction heating, and is useful for an image forming apparatus such as an electrophotographic or electrostatographic copier, facsimile machine, or printer.

1. A fixing apparatus comprising:
a heat-producing element that is composed of a temperature sensitive magnetic material that becomes basically nonmagnetic at or above a predetermined temperature, and extends across an entire width of a recording material;
an exciting section provided with an exciting coil that performs excitation heating of an entire width orthogonal to a feeding direction of the recording material opposite the heat-producing element; and
a pressure section for bringing heat generated by the heat-producing element into contact with the recording material,
wherein a Curie temperature Tc of the temperature sensitive magnetic material is made 220° C. or lower, and a fixing set temperature of the heat-producing element corresponding to a part where the recording material passes during continuous paper feeding is set to a value lower than a temperature Ts at which relative magnetic permeability of the temperature sensitive magnetic material begins to fall.

2. The fixing apparatus according to claim 1, wherein Curie temperature Tc of the temperature sensitive magnetic material and temperature Ts at which relative magnetic permeability of the temperature sensitive magnetic material begins to fall are set so that Tc−Ts≦30° C.

3. The fixing apparatus according to claim 1, wherein the heat-producing element has a laminated configuration in which a nonmagnetic electrically conductive layer is provided on the exciting coil side of the temperature sensitive magnetic material.

4. The fixing apparatus according to claim 1, wherein a thickness of the temperature sensitive magnetic material is at least 0.1 mm and not more than 0.7 mm.

5. The fixing apparatus according to claim 1, wherein the temperature sensitive magnetic material is created by executing annealing treatment after a thin-walled cylindrical shape has been formed by plasticity processing of a temperature sensitive magnetic metallic material.

6. The fixing apparatus according to claim 1, further comprising a nonmagnetic electrical conductor provided opposite the exciting coil and sandwiching the heat-producing element,
wherein, due to a rise in temperature and fall in magnetic permeability of the heat-producing element, magnetic flux formed by the exciting section passes through the heat-producing element and penetrates the interior of the nonmagnetic electrical conductor.

7. The fixing apparatus according to claim 1, further comprising an endless fixing belt that is in contact with and suspended on an outer periphery of the temperature sensitive magnetic material, is in contact with the pressure section, and supplies heat to the recording material while gripping and transporting the recording material.

8. The fixing apparatus according to claim 7, wherein the temperature sensitive magnetic material is a non-rotating member; and the fixing belt moves around, sliding in contact with the temperature sensitive magnetic material.

9. The fixing apparatus according to claim 7, wherein the fixing belt has an electrically conductive heat-producing layer that produces heat itself by the exciting section.

10. The fixing apparatus according to claim 9, wherein the temperature sensitive magnetic material is a magnetic path forming section that does not produce heat itself.

11. The fixing apparatus according to claim 1, further comprising:
a fixing temperature detection section that detects a temperature of the heat-producing element corresponding to a part where the recording material passes; and
a control section that controls power supply to the exciting section based on detection information of the fixing temperature detection section,
wherein, by the control section, a fixing temperature of a part where the recording material passes is controlled at a constant temperature, and temperature outside a width of the recording material is auto-temperature-controlled at a temperature between temperature Ts at which relative magnetic permeability of the temperature sensitive magnetic material begins to fall and Curie temperature Tc of the temperature sensitive magnetic material.

12. The fixing apparatus according to claim 1, wherein the exciting section has applied thereto a current whose frequency is from 20 kHz to 60 kHz.

13. An image forming apparatus comprising the fixing apparatus according to claim 1.

14. An induction heating roller composed of a temperature sensitive magnetic material that becomes basically nonmagnetic at or above a predetermined temperature,
wherein the induction heating roller is used in a fixing apparatus in which a Curie temperature Tc of the temperature sensitive magnetic material is made 220° C. or lower, and a temperature Ts at which relative magnetic permeability of the temperature sensitive magnetic material begins to fall is set to a temperature higher than a fixing temperature.

15. The induction heating roller according to claim 14, wherein Curie temperature Tc of the temperature sensitive magnetic material and temperature Ts at which relative magnetic permeability of the temperature sensitive magnetic material begins to fall are set so that Tc−Ts≦30° C.
